(19) United States
(12) Patent Application Publication
(10) Pub. No.: US 2017/0329087 A1
(43) Pub. Date: Nov. 16, 2017

(54) OPTICAL DEMULTIPLEXING DEVICE AND METHOD

(71) Applicant: ELECTRONICS AND TELECOMMUNICATIONS RESEARCH INSTITUTE, Daejeon (KR)

(72) Inventors: Joon Young HUH, Daejeon (KR); Sae-Kyoung KANG, Daejeon (KR); Joon Ki LEE, Daejeon (KR); Jie Hyun LEE, Daejeon (KR)

(21) Appl. No.: 15/484,359

(22) Filed: Apr. 11, 2017

(30) Foreign Application Priority Data
May 16, 2016 (KR) 10-2016-0059753
Jan. 4, 2017 (KR) 10-2017-0001448

(51) Int. Cl. G02B 6/293; G02B 6/42

(52) U.S. Cl. CPC G02B 6/29365; G02B 6/2938; G02B 6/4214

(57) ABSTRACT

An optical demultiplexing device includes a demultiplexer configured to demultiplex an input light into lights of different wavelength bands, and output the lights of different wavelength bands in a first direction and a second direction, and a detector configured to detect the light output in the first direction and the light output in the second direction.

### CROSS-REFERENCE TO RELATED APPLICATION(S)

This application claims the priority benefit of Korean Patent Application No. 10-2016-0059753, filed on May 16, 2016, and Korean Patent Application No. 10-2017-0001448, filed on Jan. 4, 2017, in the Korean Intellectual Property Office, the disclosures of which are incorporated herein by reference for all purposes.

### BACKGROUND

### 1. Field

One or more example embodiments relate to an optical demultiplexing device and method.

### 2. Description of Related Art

An optical transceiver may generate an optical signal using a received electric signal or generate an electric signal using a received optical signal. With a recent sharp increase in traffic, various efforts are being made to increase a transmission capacity of the optical transceiver.

Wavelength-division multiplexing (WDM) is a scheme that multiplexes and transmits multi-wavelength optical signals onto a single optical fiber. The WDM scheme is used for medium, long-range optical transmission networks, and also applied to short-range optical transmission networks such as Ethernet.

To multiplex or demultiplex wavelengths, a more effective optical multiplexing or optical demultiplexing method is needed.

### SUMMARY

An aspect provides an efficient optical demultiplexing method using a thin film filter in multi-wavelength optical receiver modules of large capacities.

According to an aspect, there is provided an optical demultiplexing device including a demultiplexer configured to demultiplex an input light into lights of different wavelength bands, and output the lights of different wavelength bands in a first direction and a second direction, and a detector configured to detect the light output in the first direction and the light output in the second direction.

The demultiplexer may include a thin film filter configured to pass a light of one band among the lights of different wavelength bands, and reflect a light of another band.

The optical demultiplexing device may further include a first reflector configured to reflect the light output in the first direction from the demultiplexer, and a second reflector configured to reflect the light output in the second direction from the demultiplexer.

The optical demultiplexing device may further include a third reflector configured to reflect the input light toward the demultiplexer.

The demultiplexer may include a thin film filter configured to pass a predetermined wavelength of the light reflected by the third reflector, and reflect wavelengths other than the predetermined wavelength.

The thin film filter may include a first thin film filter configured to pass a first wavelength group among wavelengths of the light reflected by the third reflector, and reflect a second wavelength group excluding the first wavelength group among the wavelengths of the light reflected by the third reflector.

The thin film filter may further include a second thin film filter configured to pass the second wavelength group among the wavelengths of the light reflected by the third reflector, and reflect the first wavelength group excluding the second wavelength group among the wavelengths of the light reflected by the third reflector.

The third reflector may be combined with at least a portion of the demultiplexer.

According to another aspect, there is also provided an optical demultiplexing device including a demultiplexer configured to demultiplex an input light into lights of different wavelength bands, and output the demultiplexed lights in both directions, and a detector configured to detect the output demultiplexed lights.

According to still another aspect, there is also provided an optical demultiplexing method including demultiplexing an input light into lights of different wavelength bands using a demultiplexer, outputting the lights of different wavelength bands in a first direction and a second direction, and detecting the light output in the first direction and the light output in the second direction.

The outputting may include outputting a light in the first direction from one side of the demultiplexer, and outputting a light in the second direction from another side of the demultiplexer.

The demultiplexing may include passing a light of one band among the lights of different wavelength bands, and reflecting a light of another band using a thin film filter.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a configuration of an optical demultiplexing device according to an example embodiment;

FIG. 2 illustrates an operation of an optical demultiplexing device according to an example embodiment;

FIG. 3 illustrates an operation of an optical demultiplexing device according to an example embodiment;

FIG. 4 illustrates a design structure of a demultiplexer according to an example embodiment;

FIG. 5 is a flowchart illustrating an optical demultiplexing method according to an example embodiment; and

FIG. 6 illustrates an operation of an optical demultiplexing device according to an example embodiment.

### DETAILED DESCRIPTION

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

In case it is mentioned that a certain component is “connected” or “accessed” to another component, it may be understood that the certain component is directly connected or accessed to the another component or that a component is interposed between the components. On the contrary, in case it is mentioned that a certain component is “directly connected” or “directly accessed” to another component, it should be understood that there is no component therebetween.

Terms used in the present invention is to merely explain specific embodiments, thus it is not meant to be limiting. A singular expression includes a plural expression except that two expressions are contextually different from each other. In the present invention, a term “include” or “have” is intended to indicate that characteristics, figures, steps, operations, components, elements disclosed on the specification or combinations thereof exist. Rather, the term “include” or “have” should be understood so as not to pre-exclude existence of one or more other characteristics, figures, steps, operations, components, elements or combinations thereof or additional possibility.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

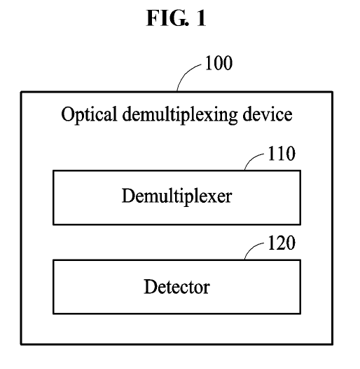

FIG. 1 is a block diagram illustrating a configuration of an optical demultiplexing device according to an example embodiment.

Referring to FIG. 1, an optical demultiplexing device 100 may include a demultiplexer 110, and a detector 120. The demultiplexer 110 may demultiplex an input light into lights of difference wavelength bands, and output the lights of different wavelength bands in a first direction and a second direction.

The demultiplexer 110 may output a light in the first direction from one side of the demultiplexer 110, and output a light in the second direction from another side of the demultiplexer 110. Further, the demultiplexer 110 may include a thin film filter configured to pass a light of one band among the lights of different wavelength bands, and reflect a light of another band. The detector 120 may detect the light output in the first direction and the light output in the second direction.

The optical demultiplexing device 100 may further include a first reflector and a second reflector. The first reflector may reflect the light output in the first direction from the demultiplexer 110. The second reflector may reflect the light output in the second direction from the demultiplexer 110.

The optical demultiplexing device 100 may further include a third reflector. The third reflector may to reflect the input light toward the demultiplexer 110. Meanwhile, the third reflector may be combined with at least a portion of the demultiplexer 110.

The demultiplexer 110 may include a thin film filter configured to pass a predetermined wavelength of the light reflected by the third reflector, and reflect wavelengths other than the predetermined wavelength. The thin film filter may include a first thin film filter configured to pass a first wavelength group among wavelengths of the light reflected by the third reflector, and reflect a second wavelength group excluding the first wavelength group among the wavelengths of the light reflected by the third reflector.

The thin film filter may further include a second thin film filter configured to pass the second wavelength group among the wavelengths of the light reflected by the third reflector, and reflect the first wavelength group excluding the second wavelength group among the wavelengths of the light reflected by the third reflector.

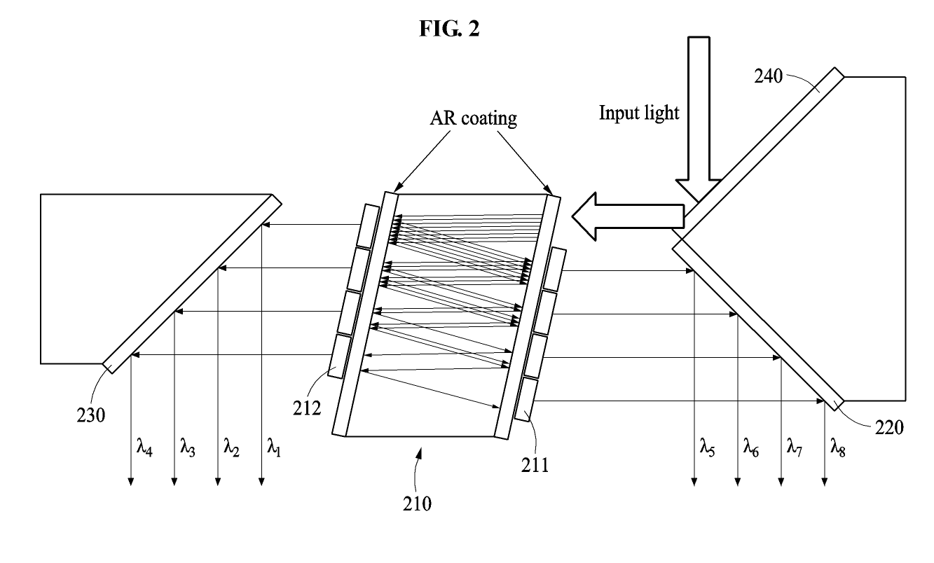

FIG. 2 illustrates an operation of an optical demultiplexing device according to an example embodiment.

Referring to FIG. 2, an optical demultiplexing device 200 may include a demultiplexer 210, and reflectors such as a first reflector 220, a second reflector 230, and a third reflector 240. In this example, the first reflector 220, the second reflector 230, and the third reflector 240 may each be a reflecting plate having a slope of a predetermined angle with respect to a direction of incidence of an input light. However, example embodiments are not limited thereto. The demultiplexer 210 may also have a slope of a predetermined angle with respect to the direction of incidence of the input light.

The demultiplexer 210 or each reflector may have a different slope. There may be components having the same slope, similar to a portion of the plurality of reflectors. For example, the first reflector 220 and the third reflector 240 may be parallel to each other. Further, in an example, the first reflector 220 may be parallel to the second reflector 230.

The demultiplexer 210 may demultiplex the input light into lights of different wavelength bands, and output the lights of different wavelength bands in both directions, a first direction and a second direction, in an example, simultaneously. The first reflector 220 may reflect the light output in the first direction from the demultiplexer 210, and the second reflector 230 may reflect the light output in the second direction from the demultiplexer 210.

The demultiplexer 210 may demultiplex the input light into lights of first to eighth wavelengths. Further, the demultiplexer 210 may output the lights of first to fourth wavelengths in a left direction of the demultiplexer 210, and output the lights of fifth to eighth wavelengths in a right direction of the demultiplexer 210.

Meanwhile, the second reflector 230 disposed on a left side of the demultiplexer 210 may vertically reflect the lights of first to fourth wavelengths output in the left direction from the demultiplexer 210. Further, the first reflector 220 disposed on a right side of the demultiplexer 210 may vertically reflect the lights of fifth to eighth wavelengths output in the right direction from the demultiplexer 210.

The third reflector 240 may reflect the input light toward the demultiplexer 210. Meanwhile, the third reflector 240 may be disposed to be parallel to the first reflector 220 or the second reflector 230. The third reflector 240 may also be disposed to be vertical to the first reflector 220 or the second reflector 230. In an example, the third reflector 240 may be combined with at least a portion of the demultiplexer 210.

The slope of the third reflector 240 may be determined based on a slope of the light reflected by the first reflector 220 or the second reflector 230.

The demultiplexer 210 may include a thin film filter configured to pass a predetermined wavelength of the light reflected by the third reflector 240, and reflect wavelengths other than the predetermined wavelength. The thin film filter may be a thin thin film filter. In this example, the slope of the third reflector 240 may be determined based on a slope of the thin film filter. In another example, the slope of the third reflector 240 may be determined based on a refractive index of an internal medium or an external medium of the demultiplexer 210 based on the thin film filter.

The thin film filter may include a first thin film filter configured to pass a first wavelength group among wavelengths of the light reflected by the third reflector 240, and reflect a second wavelength group excluding the first wavelength group among the wavelengths of the light reflected by the third reflector 240. In this example, the first wavelength group may include the first to fourth wavelengths, and the second wavelength group may include the fifth to eighth wavelengths. However, example embodiments are not limited thereto.

The thin film filter may further include a second thin film filter configured to pass the second wavelength group among the wavelengths of the light reflected by the third reflector 240, and reflect the first wavelength group excluding the second wavelength group among the wavelengths of the light reflected by the third reflector 240. In this example, the first thin film filter and the second thin film filter may be disposed to be parallel to each other.

The first thin film filter and the second thin film filter may each include a plurality of thin film filters. For example, the first thin film filter may include a 1-1th thin film filter, a 1-2th thin film filter, a 1-3th thin film filter, and a 1-4th thin film filter. The 1-1th thin film filter, the 1-2th thin film filter, the 1-3th thin film filter, and the 1-4th thin film filter may be horizontally arranged. In this example, the 1-1th thin film filter may reflect wavelengths except for the fifth wavelength, and the 1-2th thin film filter may reflect wavelengths except for the sixth wavelength. Further, the 1-3th thin film filter may reflect wavelengths except for the seventh wavelength, and the 1-4th thin film filter may reflect wavelengths except for the eighth wavelength. That is, the 1-1th thin film filter may refract or pass the fifth wavelength, and the 1-2th thin film filter may refract or pass the sixth wavelength. Further, the 1-3th thin film filter may refract or pass the seventh wavelength, and the 1-4th thin film filter may refract or pass the eighth wavelength.

The second thin film filter may include a 2-1th thin film filter, a 2-2th thin film filter, a 2-3th thin film filter, and a 2-4th thin film filter. The 2-1th thin film filter, the 2-2th thin film filter, the 2-3th thin film filter, and the 2-4th thin film filter may be horizontally arranged. In this example, the 2-1th thin film filter may reflect wavelengths except for the first wavelength, and the 2-2th thin film filter may reflect wavelengths except for the second wavelength. Further, the 2-3th thin film filter may reflect wavelengths except for the third wavelength, and the 2-4th thin film filter may reflect wavelengths except for the fourth wavelength. That is, the 2-1th thin film filter may refract or pass the first wavelength, and the 2-2th thin film filter may refract or pass the second wavelength. Further, the 2-3th thin film filter may refract or pass the third wavelength, and the 2-4th thin film filter may refract or pass the fourth wavelength.

The direction of the input light being applied may be changed when the input light passes through the third reflector 240. In this example, the optical signal of which the direction is changed by the third reflector 240 may be applied to the demultiplexer 210 with both sides on which thin film filters 211 and 212, for example, thin thin film filters, are attached thereto.

The input optical signal may be reflected by the third reflector 240.

Wavelengths of the optical signal may be separated by the thin film filters 211 and 212 and output from the demultiplexer 210. In this example, the separated wavelengths may be λ₁, λ₂, λ₃, λ₄, λ₅, and λ₆. However, example embodiments are not limited thereto. Among the separated wavelengths, the wavelengths λ₁, λ₂, λ₃, and λ₄ may be output from the demultiplexer 210 toward the second reflector 230 disposed on the left side of the demultiplexer 210. Among the separated wavelengths, the wavelengths λ₅, λ₆, λ₇, and λ₈ may be output from the demultiplexer 210 toward the first reflector 220 disposed on the right side of the demultiplexer 210. Further, optical signals of the separated wavelengths may be separately reflected and externally output by the first reflector 220 or the second reflector 230.

High-reflection (HR) coating for reflection may be performed on at least one of the first reflector 220, the second reflector 230, or the third reflector 240. In addition, anti-reflection (AR) coating for anti-reflection may be performed on portions between the demultiplexer 210 and the thin film filters 211 and 212.

The demultiplexer 210 on which the thin thin film filters 211 and 212 are disposed in both directions may experience an optical path length similar to four channels and perform demultiplexing, when compared to a case of disposing a thin film in one direction although the number of wavelengths increases to “8”.

The third reflector 240 and the second reflector 230 may be disposed to be parallel to each other, and the third reflector 240 and the first reflector 220 may be disposed to be vertical to each other. In this example, a position of incident of light may be set through a position or the slope of the third reflector 240. Meanwhile, the optical demultiplexing device 200 may adjust output positions of the eight wavelengths, separately for four wavelengths each.

The reflectors such as the first reflector 220, the second reflector 230, and the third reflector 240 of the optical demultiplexing device 200 may be produced in various shapes. For example, the third reflector 240 and the first reflector 220 may be implemented in a combination structure. In an example, the third reflector 240 and the first reflector 220 may be produced separately.

The shape of the reflectors of the optical demultiplexing device 200 may include a trapezoid, a parallelogram, and a triangle, and may be set based on a processing method. Further, in an example, the first reflector 220 and the second reflector 230 of the optical demultiplexing device 200 may be removed based on a position of a light receiving device. However, since the incident light and the output light are proximate to each other, the optical demultiplexing device 200 may include one of the third reflector 240 and the first reflector 220 for ease control.

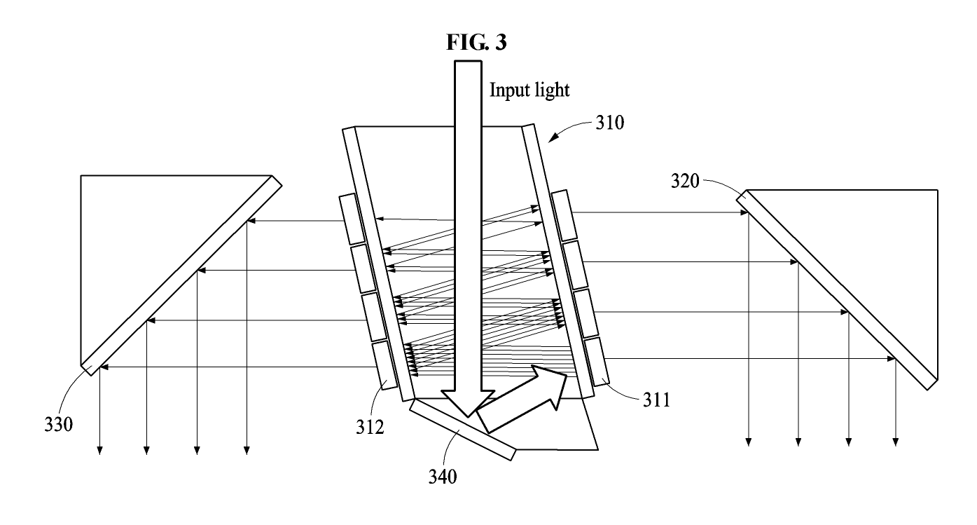

FIG. 3 illustrates an operation of an optical demultiplexing device according to an example embodiment.

Referring to FIG. 3, a position change of a third reflector 340 is illustrated. The third reflector 340 and a demultiplexer 310 may be disposed in a combined structure. In this example, when producing an optical demultiplexing device, a body of the demultiplexer 310 and the third reflector 340 may be produced in a combined form.

For easy production, the body of the demultiplexer 310 and a block of the third reflector 340 may be produced separately, and joined manually later. In this example, the third reflector 340 and a first reflector 320 may be disposed to be parallel to each other, and the third reflector 340 and a second reflector 330 may be disposed to be vertical to each other.

An input light may be reflected by the third reflector 340, and wavelengths thereof may be separated by thin film filters 311 and 312 and output from the demultiplexer 310. Further, optical signals of the separated wavelengths may be reflected and externally output by the first reflector 320 or the second reflector 330. In this example, HR coating for reflection may be performed on at least one of the first reflector 320, the second reflector 330, or the third reflector 340. In addition, AR coating for anti-reflection may be performed on portions between the demultiplexer 310 and the thin film filters 311 and 312.

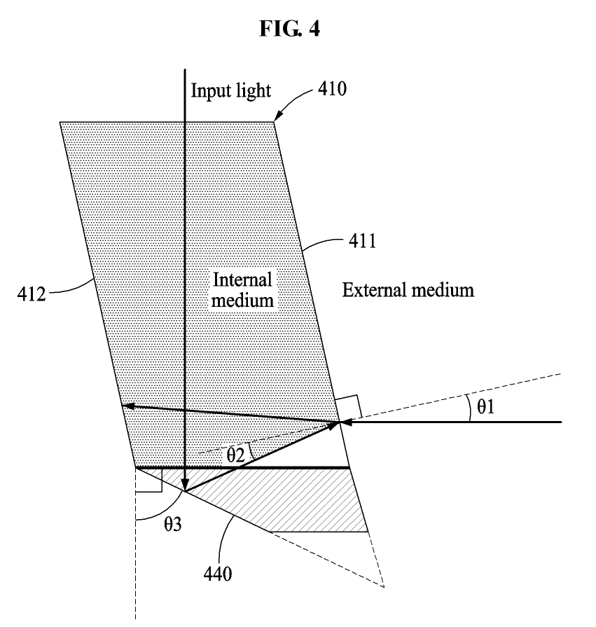

FIG. 4 illustrates a design structure of a demultiplexer according to an example embodiment.

Referring to FIG. 4, an optical demultiplexing device may include a third reflector 440 combined with a lower portion of a demultiplexer 410. For example, when producing the optical demultiplexing device, the third reflector 440 may be combined with a body of the demultiplexer 410. Meanwhile, for easy production of the optical demultiplexing device, the body of the demultiplexer 410 and a block of the third reflector 440 may be produced separately, and joined manually layer. An angle θ3 of the third reflector 440 may be set or determined based on an angle θ1 between a light reflected and output by the first reflector 420 or the second reflector 430 and a thin film filter 411 which is a thin film filter, a refractive index n1 of an external medium of the thin film filter 411, and a refractive index n2 of an internal medium between thin film filters 411 and 412. For example, the angle θ3 of the third reflector 440 may be determined using Equations 1 and 2. In a case in which the third reflector 440 arbitrarily meets a predetermined horizontal line in a direction of the input light, the angle θ3 may be an angle formed therebetween. Further, an angle θ2 may be an angle of incidence or an angle of reflection in a case in which an optical signal corresponding to the input light reflected by the third reflector 440 is reflected by the thin film filter 411. Meanwhile, in a case in which a normal on a boundary surface of the thin film filter arbitrarily meets a predetermined vertical line in the direction of the input light, the angle θ1 may be an angle formed therebetween.

n1×sin(θ1)=n2×sin(θ2) [Equation 1]

(θ3−θ1)+θ3+(90°−θ2)=180° [Equation 2]

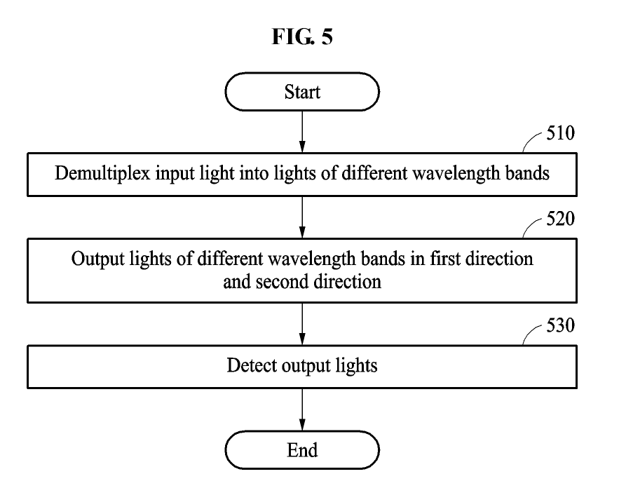

FIG. 5 is a flowchart illustrating an optical demultiplexing method according to an example embodiment.

Referring to FIG. 5, an optical demultiplexing method performed by the optical demultiplexing device as shown in at least one of FIGS. 1 through 4, and 6 may include the following operations.

In operation 510, the optical demultiplexing device may demultiplex an input light into lights of different wavelength bands using a demultiplexer. The optical demultiplexing device may pass a light of one band among the lights of different wavelength bands, and reflect a light of another band using a thin film filter.

In operation 520, the optical demultiplexing device may output the lights of different wavelength bands in a first direction and a second direction. The optical demultiplexing device may output a light in the first direction from one side of the demultiplexer, and output a light in the second direction from another side of the demultiplexer.

In operation 530, the optical demultiplexing device may detect the light output in the first direction and the light output in the second direction.

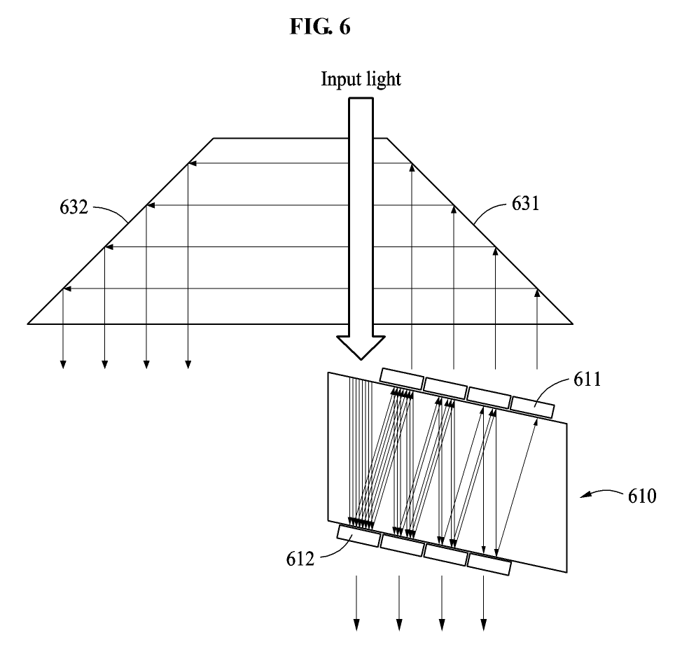

FIG. 6 illustrates an operation of an optical demultiplexing device according to an example embodiment.

Referring to FIG. 6, an input light which enters an optical demultiplexing device may be demultiplexed by a demultiplexer 610, and the demultiplexed lights may be output in both directions of the demultiplexer 610. The output lights may include lights of a plurality of wavelengths in different bands. A portion of the plurality of wavelengths may be reflected by reflectors. The plurality of wavelengths may pass through predetermined thin film filters, respectively. Wavelengths other than a predetermined wavelength may be reflected by a predetermined thin film filter. Lights of a first wavelength, a third wavelength, a fifth wavelength, and a seventh wavelength may pass through a 1-1th thin film filter, a 1-2th thin film filter, a 1-3th thin film filter, and a 1-4th thin film filter, respectively. Lights of a second wavelength, a fourth wavelength, a sixth wavelength, and an eighth wavelength may pass through a 2-1th thin film filter, a 2-2th thin film filter, a 2-3th thin film filter, and a 2-4th thin film filter, respectively.

The input light may enter the demultiplexer 610. A first thin film filter 612 included in or attached to the demultiplexer 610 may reflect remaining wavelengths except for one wavelength. In the input light, at least one light of the first wavelength may pass through the first thin film filter 612. The first thin film filter 612 may include the 1-1th thin film filter, the 1-2th thin film filter, the 1-3th thin film filter, and the 1-4th thin film filter. The 1-1th thin film filter, the 1-2th thin film filter, the 1-3th thin film filter, the 1-4th thin film filter may be horizontally disposed to be proximate to each other sequentially in a row. The passed light of the first wavelength may be a first output wavelength that is output from the optical demultiplexing device.

Among the remaining wavelengths reflected by the first thin film filter 612, at least one light of the second wavelength may pass through a second thin film filter 611. The second thin film filter 611 may be included in or attached to the demultiplexer 610, and disposed to be parallel to the first thin film filter 612 on an opposite side. The second thin film filter 611 may include the 2-1th thin film filter, the 2-2th thin film filter, the 2-3th thin film filter, and the 2-4th thin film filter. The 2-1th thin film filter, the 2-2th thin film filter, the 2-3th thin film filter, and the 2-4th thin film filter may be horizontally disposed to be proximate to each other sequentially in a row. The lights demultiplexed and output by the demultiplexer 610 may be reflected by reflectors 631 and 632 to proceed toward a detector. The light of the second wavelength passing through the second thin film filter 611 may be reflected at 90 degrees by the first reflector 631. The reflected light of the second wavelength may be reflected again at 90 degrees by the second reflector 632. The light of the second wavelength reflected by the second reflector 632 may be a second output wavelength that is output from the optical demultiplexing device. Meanwhile, virtual extension planes of respective surfaces of the first reflector 631 and the second reflector 632 may be at a right angle.

Among the remaining wavelengths reflected by the first thin film filter 612 and reflected again by the second thin film filter 611, at least one light of the third wavelength may pass through the first thin film filter 612. Remaining wavelengths except for the third wavelength passing through the first thin film filter 612 may be reflected again by the first thin film filter 612. The passed light of the third wavelength may be a third output wavelength that is output from the optical demultiplexing device.

Among the remaining wavelengths reflected by the first thin film filter 612, reflected again by the second thin film filter 611, and then reflected again by the first thin film filter 612, at least one light of the fourth wavelength may pass through the second thin film filter 611. The remaining wavelengths except for the fourth wavelength passing through the second thin film filter 611 may be reflected again by the second thin film filter 611. The passed light of the fourth wavelength may be reflected at 90 degrees by the first reflector 631. The reflected light of the fourth wavelength may be reflected again at 90 degrees by the second reflector 632. The light of the fourth wavelength reflected by the second reflector 632 may be a fourth output wavelength that is output from the optical demultiplexing device.

Among the remaining wavelengths reflected sequentially by the first thin film filter 612, the second thin film filter 611, the first thin film filter 612, and the second thin film filter 611, at least one light of the fifth wavelength may pass through the first thin film filter 612. The remaining wavelengths except for the fifth wavelength passing through the first thin film filter 612 may be reflected again by the first thin film filter 612. The passed light of the fifth wavelength may be a fifth output wavelength that is output from the optical demultiplexing device.

Among the remaining wavelengths reflected sequentially by the first thin film filter 612, the second thin film filter 611, the first thin film filter 612, the second thin film filter 611, and the first thin film filter 612, at least one light of the sixth wavelength may pass through the second thin film filter 611. The remaining wavelengths except for the sixth wavelength passing through the second thin film filter 611 may be reflected again by the second thin film filter 611. The passed light of the sixth wavelength may be reflected at 90 degrees by the first reflector 631. The reflected light of the sixth wavelength may be reflected again at 90 degrees by the second reflector 632. The light of the sixth wavelength reflected by the second reflector 632 may be a sixth output wavelength that is output from the optical demultiplexing device.

Among the remaining wavelengths reflected sequentially by the first thin film filter 612, the second thin film filter 611, the first thin film filter 612, the second thin film filter 611, the first thin film filter 612, and the second thin film filter 611, at least one light of the seventh wavelength may pass through the first thin film filter 612. Lights of the remaining wavelengths except for the seventh wavelength passing through the first thin film filter 612 may be reflected again by the first thin film filter 612. The passed light of the seventh wavelength may be a seventh output wavelength that is output from the optical demultiplexing device.

Among the remaining wavelengths reflected sequentially by the first thin film filter 612, the second thin film filter 611, the first thin film filter 612, the second thin film filter 611, the first thin film filter 612, the second thin film filter 611, and the first thin film filter 612, at least one light of the eighth wavelength may pass through the second thin film filter 611. The passed light of the eighth wavelength may be reflected at 90 degrees by the first reflector 631. The reflected light of the eighth wavelength may be reflected again at 90 degrees by the second reflector 632. The light of the eighth wavelength reflected by the second reflector 632 may be an eighth output wavelength that is output from the optical demultiplexing device.

HR coating for reflection may be performed on at least one of the first reflector 631 or the second reflector 632. In addition, AR coating for anti-reflection may be performed on portions between the demultiplexer 610 and the thin film filters 611 and 612.

According to an example embodiment, a relatively high mass productivity may be provided using a scheme of reducing an optical path.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical demultiplexing device comprising:
a demultiplexer configured to demultiplex an input light into lights of different wavelength bands, and output the lights of different wavelength bands in a first direction and a second direction; and
a detector configured to detect the light output in the first direction and the light output in the second direction.

2. The optical demultiplexing device of claim 1, wherein the demultiplexer comprises a thin film filter configured to pass a light of one band among the lights of different wavelength bands, and reflect a light of another band.

3. The optical demultiplexing device of claim 1, further comprising:
a first reflector configured to reflect the light output in the first direction from the demultiplexer; and
a second reflector configured to reflect the light output in the second direction from the demultiplexer.

4. The optical demultiplexing device of claim 3, further comprising:
a third reflector configured to reflect the input light toward the demultiplexer.

5. The optical demultiplexing device of claim 4, wherein the demultiplexer comprises a thin film filter configured to pass a predetermined wavelength of the light reflected by the third reflector, and reflect wavelengths other than the predetermined wavelength.

6. The optical demultiplexing device of claim 5, wherein the thin film filter comprises a first thin film filter configured to pass a first wavelength group among wavelengths of the light reflected by the third reflector, and reflect a second wavelength group excluding the first wavelength group among the wavelengths of the light reflected by the third reflector.

7. The optical demultiplexing device of claim 6, wherein the thin film filter further comprises a second thin film filter configured to pass the second wavelength group among the wavelengths of the light reflected by the third reflector, and reflect the first wavelength group excluding the second wavelength group among the wavelengths of the light reflected by the third reflector.

8. The optical demultiplexing device of claim 4, wherein the third reflector is combined with at least a portion of the demultiplexer.

9. An optical demultiplexing device comprising:
a demultiplexer configured to demultiplex an input light into lights of different wavelength bands, and output the demultiplexed lights in both directions; and
a detector configured to detect the output demultiplexed lights.

10. The optical demultiplexing device of claim 9, wherein the demultiplexer comprises a thin film filter configured to pass a light of one band among the lights of different wavelength bands, and reflect a light of another band.

11. The optical demultiplexing device of claim 9, further comprising:
a reflector configured to reflect the lights output from the demultiplexer toward the detector.

12. An optical demultiplexing method comprising:
demultiplexing an input light into lights of different wavelength bands using a demultiplexer;
outputting the lights of different wavelength bands in a first direction and a second direction; and
detecting the light output in the first direction and the light output in the second direction.

13. The optical demultiplexing method of claim 12, wherein the outputting comprises outputting a light in the first direction from one side of the demultiplexer, and outputting a light in the second direction from another side of the demultiplexer.

14. The optical demultiplexing method of claim 12, wherein the demultiplexing comprises passing a light of one band among the lights of different wavelength bands, and reflecting a light of another band using a thin film filter.
